(19) United States
(12) Patent Application Publication
(10) Pub. No.: US 2015/0378865 A1
(43) Pub. Date: Dec. 31, 2015

(54) SYSTEM AND METHOD FOR PROVIDING ERROR DETECTION AND NOTIFICATION

(71) Applicant: VERIZON PATENT AND LICENSING INC., Arlington, VA (US)

(72) Inventor: James A. ROBERTSON, The Woodlands, TX (US)

(21) Appl. No.: 14/314,877

(22) Filed: Jun. 25, 2014

(51) Int. Cl. G06F 11/34; G06F 11/30

(52) U.S. Cl. CPC G06F 11/3495; G06F 11/3006; G06F 11/3065

(57) ABSTRACT

An approach is provided for registering an expected event associated with trouble management for a computing environment. The approach also involves monitoring, over a predetermined period, for one or more events relating to one or more actions performed by one or more elements of the computing environment. The approach further involves determining an absence of the expected event from the one or more events for the predetermined period. The approach also involves generating an alarm message in response to the absence of the expected event.

### BACKGROUND INFORMATION

Modern information and communication systems are vital to business operations, such that any interruption may impose a significant cost to the business. The process of error detection is an important productivity criterion for developing and maintaining information and communication systems. Similarly, the ability to cause error notification to an appropriate party is critical to building a fault resilient system. At present, common practice in error detection mechanisms involves processing activities posting error milestones to logging facilities; however, when processing goes wrong or systems fail the error detection, communications and other processing mechanisms may lack sufficient viability to notify error milestones to the logs. This method of error detection is ineffective, and has both cost and quality implications.

As a result, a system for automated error detection based on the absence of success during a predetermined time period is required.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system capable of determining an absence of an expected event during a predetermined period and causing a notification in response to the determined absence, according to one embodiment;

FIG. 2 is a diagram of the components of the trouble management platform 115, according to one embodiment;

FIG. 3 is a diagram that represents the implementation process of the expected outcome service 303, according to one embodiment;

FIG. 4 is a diagram that represents a comprehensive functioning of a developed expected outcome service 303, according to one embodiment;

FIG. 5 is a flowchart of a process for automated error detection based on the absence of success during a predetermined time period, according to one embodiment;

FIG. 6 is a flowchart of a process for receiving a response message to determine whether a log entry corresponds to the expected event, according to one embodiment;

FIG. 7 is a flowchart of a process for generating a log, and monitoring a log to detect successful processing within a registered time period, according to one embodiment;

FIG. 8 A-B are ladder diagrams that represents a scenario on handling recurring expectations using the combination of timer service and expected outcome service, according to one example embodiment;

FIG. 9 is a diagram of a computer system that can be used to implement various exemplary embodiments; and

FIG. 10 is a diagram of a chip set that can be used to implement various exemplary embodiments.

### DESCRIPTION OF THE PREFERRED EMBODIMENT

An apparatus, method, and software for determining an absence of an expected event during a predetermined period and causing a notification in response to the determined absence, is described. In the following description, for the purposes of explanation, numerous specific details are set forth in order to provide a thorough understanding of the present invention. As is well known, the present invention may be practiced without these specific details or with an equivalent arrangement. In other instances, well-known structures and devices are shown in block diagram form in order to avoid unnecessarily obscuring the present invention.

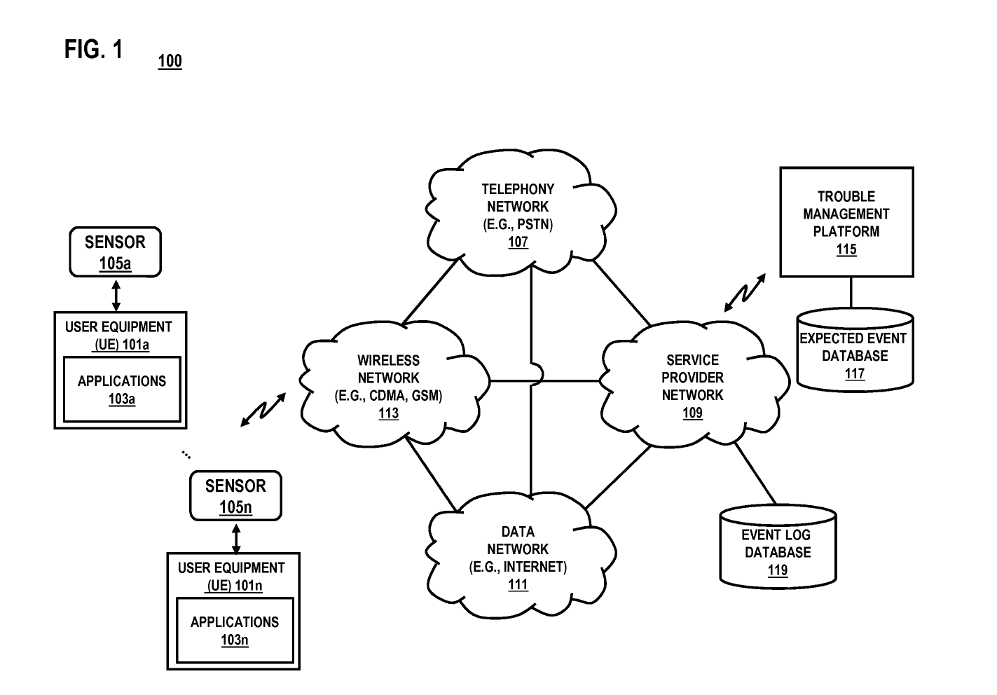

As shown in FIG. 1, the system 100 comprises of user equipment (UE) 101a-101n (collectively referred to as UE 101) that may include or be associated with applications 103a-103n (collectively referred to as applications 103) and sensors 105a-105n (collectively referred to as sensors 105). In one embodiment, the UE 101 has connectivity to the trouble management platform 115 via networks 107-113. In one embodiment, the trouble management platform 115 performs one or more functions associated with determining an absence of an expected event during a predetermined period and causing a notification in response to the determined absence, or a combination thereof.

The system 100 relates to a system for automated detection of errors, and the subsequent raising of alarms to gather the attention of applicable authority. At present, other trouble management systems take a different approach to error detection. In one example embodiment, one or more of the present trouble management systems monitors event logs for one or more applications to detect the occurrence of errors. Typically, the process involve configuration of one or more trouble management systems to perform pattern matching against log entries to detect an error pattern or a failure pattern. In contrast, the system 100 detects the absence of good things that were expected to occur during some anticipated time window. In one example embodiment, the system 100 may lookout for the appearance of a ‘success’ entry in a log with a time stamp within the expected time window.

In one embodiment, the system 100 may cause an error notification (e.g. alarm) based, at least in part, on the failure to detect desired milestones within a deadline. In one scenario, the system 100 may determine to raise an alarm upon error detection without the need for failure entries to be present in the event logs or procedures. In one example embodiment, the system 100 may determine the duration for at least one processing to successfully reach an expected completion milestone. In one scenario, in an expected outcome method of problem detection, one would register an expectation with the system 100 prior to initiation of the processing activities. Such registered expectation encapsulates data that includes (i) a time window that estimates a start and the end time during which the successful outcome is expected to transpire, and (ii) a pattern-matching information (such as strings, dictionaries of key/value pairs, regular expressions, and the like) that serves as a template for detection of whether the expected desired outcome is realized in the expected time window. In another scenario, the time window that is specified in a registered expectation could indicate only the end time for outcome completion, leaving the start time unspecified. In yet another variation, one could specify only a time duration when registering an expectation, and the system would automatically compute the expected completion time by adding the duration value to the system clock time current at the time of the expectation registration. In one scenario, after registering such expectation with the system 100, the system 100 may initiate the processing activities.

In one embodiment, the system 100 may efficiently track expectations that ‘come due’, i.e., whose end time is reached. In one scenario, the system 100 may determine that a registered expectation has reached its end time, whereupon the system 100 may query the logging service to determine whether a log entry matching the registered pattern-matching template has been posted with a time stamp located inside the expected time window. If a matching log entry is found, then the system 100 does nothing as the expectation has been fulfilled. However, if a matching log entry is not found within the expected time window, the system 100 raises an alarm with other alarming systems. In one scenario, a user may register the expectation of the success milestone of the overall activity, not the intermediate activities. The system 100 may not worry about detailed completion of an intermediate activity, but may raise an alarm only when the overall desired end state is not reached within a reasonable elapsed time period. The system 100 may permit the review of more detailed logs to examine the reason for failure in achieving the expected overall milestone within the expected time window.

In one scenario, this approach of detecting the absence of good things has advantages over the traditional approach of detecting the presence of bad things. The reason being the ability of the system 100 to handle both situations (i) where the processing posts ‘error’ milestones rather than the expected ‘success’ milestones, and (ii) when the processing goes awry or missing in action (MIA) for some reasons, and never gets to the point where it posts an ‘error’ milestone to the logs. The method of detecting absence of success is more reliable than detecting active posting of failure milestones. The system 100 supports ad hoc expectations, one-shot expectations, and recurring expectations that are registered repeatedly on a schedule.

The system 100 is well suited to event-driven processing environments, where events of different types can happen at times not known a priori, not following a regular schedule. In some embodiments of system 100, the occurrence of such events results in the system both spawning processing activities appropriate to the event type, and registering expectations of outcome patterns and time windows so that the system can ascertain whether the triggered activities proceeded as expected. In one scenario, there may be an occurrence of an event cascade, wherein an event may trigger some activity which may then spawn another event that triggers more activity, and so on. When such event cascades are possible, application designers are free to choose whether to register expectations that track intermediate task completion at a fine granularity, or alternatively to register only coarse-granularity expectations that ascertain overall outcomes.

By way of example, the UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the applications 103 may be any type of application that is executable at the UE 101, such as media player applications, social networking applications, calendar applications, content provisioning services, location-based service applications, navigation applications and the like. In one embodiment, one of the applications 103 at the UE 101 may act as a client for the trouble management platform 115 and may perform one or more functions associated with the functions of the trouble management platform 115 by interacting with the trouble management platform 115 over the networks 107-113.

By way of example, the sensors 105 may be any type of sensor. In certain embodiments, the sensors 105 may include, for example, a global positioning sensor for gathering location data (e.g., GPS), a network detection sensor for detecting wireless signals or receivers for different short-range communications (e.g., Bluetooth, WiFi, Li-Fi, near field communication etc.), temporal information, a camera/imaging sensor for gathering image data, an audio recorder for gathering audio data, and the like. In one scenario, the sensors 105 may include, light sensors, oriental sensors augmented with height sensor and acceleration sensor, tilt sensors, moisture sensors, pressure sensors, audio sensors (e.g., microphone), etc.

For illustrative purposes, the networks 107-113 may be any suitable wireline and/or wireless network, and be managed by one or more service providers. For example, telephony network 107 may include a circuit-switched network, such as the public switched telephone network (PSTN), an integrated services digital network (ISDN), a private branch exchange (PBX), or other like network. Wireless network 113 may employ various technologies including, for example, code division multiple access (CDMA), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), satellite, and the like. Meanwhile, data network 111 may be any local area network (LAN), metropolitan area network (MAN), wide area network (WAN), the Internet, or any other suitable packet-switched network, such as a commercially owned, proprietary packet-switched network, such as a proprietary cable or fiber-optic network.

Although depicted as separate entities, networks 107-113 may be completely or partially contained within one another, or may embody one or more of the aforementioned infrastructures. For instance, the service provider network 109 may embody circuit-switched and/or packet-switched networks that include facilities to provide for transport of circuit-switched and/or packet-based communications. It is further contemplated that networks 107-113 may include components and facilities to provide for signaling and/or bearer communications between the various components or facilities of the system 100. In this manner, networks 107-113 may embody or include portions of a signaling system 7 (SS7) network, or other suitable infrastructure to support control and signaling functions.

In one embodiment, the trouble management platform 115 may be a platform with multiple interconnected components. The trouble management platform 115 may include multiple servers, intelligent networking devices, computing devices, components and corresponding software for determining an absence of an expected event during a predetermined period and causing a notification in response to the determined absence. In addition, it is noted that the trouble management platform 115 may be a separate entity of the system 100, or included within the UE 101 (e.g., as part of the applications 103).

In one embodiment, the trouble management platform 115 may receive a registration for an expected event, whereupon the trouble management platform 115 may monitor the registered event over a predetermined period to determine absence of an expected event. Subsequently, the trouble management platform 115 may cause a notification in response to a determined absence of an expected event. In one embodiment, the trouble management platform 115 may include an event-condition action (ECA) service. The ECA service is an event driven application that allows other systems to raise events. In one embodiment, the ECA service may evaluate condition logic, and if the logic evaluates to be true, then appropriate registered action code is triggered. In other embodiments, the registered action code is triggered without an evaluation of condition logic. Such triggered actions are typically not run locally within the ECA service itself, the action execution being delegated to an agent-container service. In one scenario, the ECA service is a service-oriented switch statement. In one embodiment, such an ECA service could be configured so that when a given type of event is raised with the ECA service, the ECA service will automatically register an expectation with the trouble management platform 115, then proceed to trigger the appropriate processing activities within the agent-container service.

In one embodiment, the trouble management platform 115 may comprise of an agent-container service. The agent-container service provides a space for processing one or more activities to run in their own thread(s) of control. In one scenario, the actions that are triggered by events raised in the ECA service actually run in the agent-container service. The implementation of the agent-container service needs to be highly scalable through the use of multiple heavy service processes running on essentially any number of CPUs. Further, dynamic class loading plays an essential role in the operation of the agent-container service. In another embodiment, agent-container service's API for spawning an agent allows for the specification, by codebase URL, of the code that implements the requested processing agent. In a further scenario, HTTPD processes, acting as code servers, allow for this dynamic loading, by the agent-container service, of any requested agent.

In one embodiment, the trouble management platform 115 may support both one-shot and recurring expectations. The one-shot expectation registrations apply only for the specified time window. Once a one-shot expectation comes due and the system determines whether the expectation has been met or not and acts accordingly, then that expectation is gone from the system. The one-shot style is especially appropriate to event-driven style systems. In contrast, recurring expectations are effectively registered over and over, on some repeating schedule. These are often appropriate to problem detection associated with batch processes that likewise run on a schedule. In one scenario, a recurring behavior may be realized through a co-ordination with a timer service whose role is to trigger events and expectation registrations on a schedule. This approach uses a clean separation of duties philosophy. But other embodiments are possible. One could alternatively augment the API of the expected outcome service 303 itself to support both one-shot and recurring expectations.

In one embodiment, the trouble management platform 115 may include a document blackboard service. The document blackboard service provides a convenient mechanism for passing data documents by reference in remote service calls, as well as, providing a place for collecting together and accumulating documents on a short-term basis. The document blackboard service supports a directory-like model in its API, where folders can be created, then populated with documents, and documents can then be fetched from folders. The service also supports a leasing model, for example, when a document is placed into a folder, it can be assigned a time-based lease value. The service may purge documents whose lease has expired. One also has the option of specifying the lease as the special value ‘default’, meaning that the lease-period is set to the system default, or the special value ‘forever’, meaning that the document persists until deliberately removed.

In one embodiment, the trouble management platform 115 may include or have access to the expected event database 117 to access or store any kind of data, for example, expected time-based information, expected event information, registered event information, analysis information about the registered event, etc. Data stored in the expected event database 117 may, for instance, be provided by the UE 101, third party service providers, third party content providers. The information may be any multiple types of information that can provide means for aiding in the content provisioning and sharing process. In some embodiments the expected event database 117 may be a persistent data store, while in other embodiments the expected event database 117 could store its information in volatile memory.

In one embodiment, the trouble management platform 115 may generate a log based on storing the one or more events based on each of the one or more events and a timestamp corresponding to the time, date, and/or duration of occurrence for each of the one or more events. The trouble management platform 115 may store the log information in the event log database 119 to access the log as per requirement to determine the absence of the expected event based on the log.

According to exemplary embodiments, end user devices may be utilized to communicate over the system 100 and may include any customer premise equipment (CPE) capable of sending and/or receiving information over one or more of networks 107-113. For instance, voice terminal may be any suitable plain old telephone service (POTS) device, facsimile machine, etc., whereas mobile device (or terminal) may be any cellular phone, radiophone, satellite phone, smart phone, wireless phone, or any other suitable mobile device, such as a personal digital assistant (PDA), pocket personal computer, tablet, customized hardware, etc. Further, computing device may be any suitable computing device, such as a VoIP phone, skinny client control protocol (SCCP) phone, session initiation protocol (SIP) phone, IP phone, personal computer, softphone, workstation, terminal, server, etc.

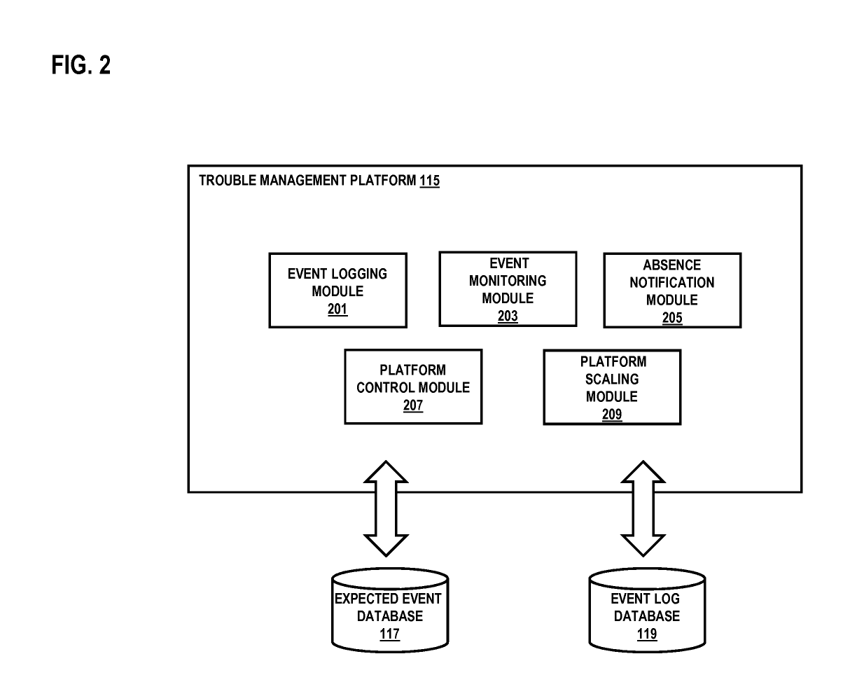

FIG. 2 is a diagram of the components of the trouble management platform 115, according to one embodiment. By way of example, the trouble management platform 115 includes one or more components for determining an absence of an expected event during a predetermined period and causing a notification in response to the determined absence. It is contemplated that the functions of these components may be combined in one or more components or performed by other components of equivalent functionality. In this embodiment, the trouble management platform 115 includes an event logging module 201, an event monitoring module 203, an absence notification module 205, a platform control module 207, and a platform scaling module 209.

In one embodiment, the event logging module 201 may allow other services and activities to post fine-grain milestone details, for example, successful completion of a processing step, an error condition, etc. The event logging module 201 may maintain a detailed historical record of event activities for future reference, especially for conducting analysis when things go bad. In another embodiment, the event logging module 201 may determine whether an expected milestone has been reached within a specified time interval. In a further embodiment, the items received by the event logging module 201 are Tuples rather than simple description strings. In one scenario, Tuples are extensible data structures along the lines of dictionaries, which associate any number of string keys with string values.

In one embodiment, the event monitoring module 203 may monitor one or more events relating to actions performed by one or more elements of the computing environment over a predetermined period. In one scenario, the event monitoring module 203 plays an important role in the detection of fault conditions. In another embodiment, the event monitoring module 203 may monitor the logs to detect the absence of good things that were expected to occur within registered time windows. In one scenario, when the event monitoring module 203 detects absence of such an expected occurrence, the event monitoring module 203 may raise an alarm. In another scenario, the design of fault detection that the event monitoring module 203 affords is able to support both scenarios wherein some processing completes with the logging of an error condition (rather than the expected success condition), and a scenario wherein an expected sequence of processing activity goes completely MIA.

In one embodiment, the absence notification module 205 may receive information on the absence of an event within an expected time window from the event monitoring module 203. In one scenario, the absence notification module 205 causes an alarm that result in human support personnel being notified of the issues. In one example embodiment, the notification via an alarm may result in an operational support person being paged and a ticket being generated in a trouble-ticketing system. In another embodiment the absence notification module may inform a report management system to, for example, append an expectation failure record to a daily report, a dashboard portal, or similar reporting mechanism. In some embodiments, the absence notification module may cause some combination of trouble ticket generation, paging of operational support persons and posting of expectation failure records to daily reports or dashboards. In some embodiments, the registration of an expectation with the trouble management platform 115 could include a severity parameter or other similar indicator which would allow, on a case by case basis, the absence notification module 205 to determine which of the plurality of alarming options (e.g. trouble ticket generation, personnel paging, appending to daily reports, posting to dashboard, etc.) should be invoked for any given failed expectation.

In one embodiment, the platform control module 207 executes at least one algorithm for executing functions of the trouble management platform 115. In one example embodiment, the platform control module 207 may execute an algorithm for processing a query associated with a computing environment for determining an error. In one embodiment, the platform control module 207 may execute an algorithm to interact with the event logging module 201 to determine whether an expected milestone has been reached within a specified time interval. In another embodiment, the platform control module 207 may execute an algorithm to interact with the event monitoring module 203 to detect absence of events expected to occur within registered time windows. In a further embodiment, the platform control module 207 may execute an algorithm to interact with the absence notification module 205 to cause an alarm when event does not happen within an expected time window. In another embodiment, the platform control module 207 may execute an algorithm to interact with the platform scaling module 209 to cause scaling of the system.

In one embodiment, the platform scaling module 209 causes a scaling of the system to accommodate large volumes of expectation registrations and large volumes of log entries. In one scenario, the registered expectations are not coupled to each other in any way, and the trouble management platform 115 is essentially observing for registered expectation to come due, whereupon it checks with the logging service to verify whether the expectation has been fulfilled. Because of this independence and lack of any coupling among the registered expectations, scaling may be achieved by simply scattering different expectation registrations randomly across any number of independent engines. In one example embodiment, the platform scaling module 209 may take incoming expectation registration requests, and for each incoming request the platform scaling module 209 may simply choose one of the engines and forward the request to the chosen engine. The platform scaling module 209 may choose the engine by any one of a number of techniques, for example, round-robin, random choice, or engine with fewest enqueued items. In another embodiment, the platform scaling module 209 may monitor the backlog of entries and may determine the need for additional engines. The platform scaling module 209 may implement various cloud techniques for provisioning an additional engine. In a further embodiment, the platform scaling module 209 may determine that the backlogs have subsided, and may take action to reduce the number of engines. In one such embodiment, this scale-back in number of engines when loads subside can be accomplished by the scaling module 209 choosing the engine with fewest registered expectations and designating that engine as the “lame duck” engine that is to be retired from service. The scaling module would cease forwarding new expectation registrations to such designated lame duck engine, after which that engine would eventually hold no remaining expectation registrations due to a sort of attrition. This process of attrition could be hastened by the scaling module 209 actively transferring some pending expectation registrations from the lame duck engine to one or more of the other engines.

The above presented modules and components of the trouble management platform 115 can be implemented in hardware, firmware, software, or a combination thereof. Though depicted as a separate entity in FIG. 1, it is contemplated that the trouble management platform 115 may be implemented for direct operation by respective UE 101. As such, the trouble management platform 115 may generate direct signal inputs by way of the operating system of the UE 101 for interacting with the applications 103. In another embodiment, one or more of the modules 201-209 may be implemented for operation by respective UEs, as a trouble management platform 115. The various executions presented herein contemplate any and all arrangements and models.

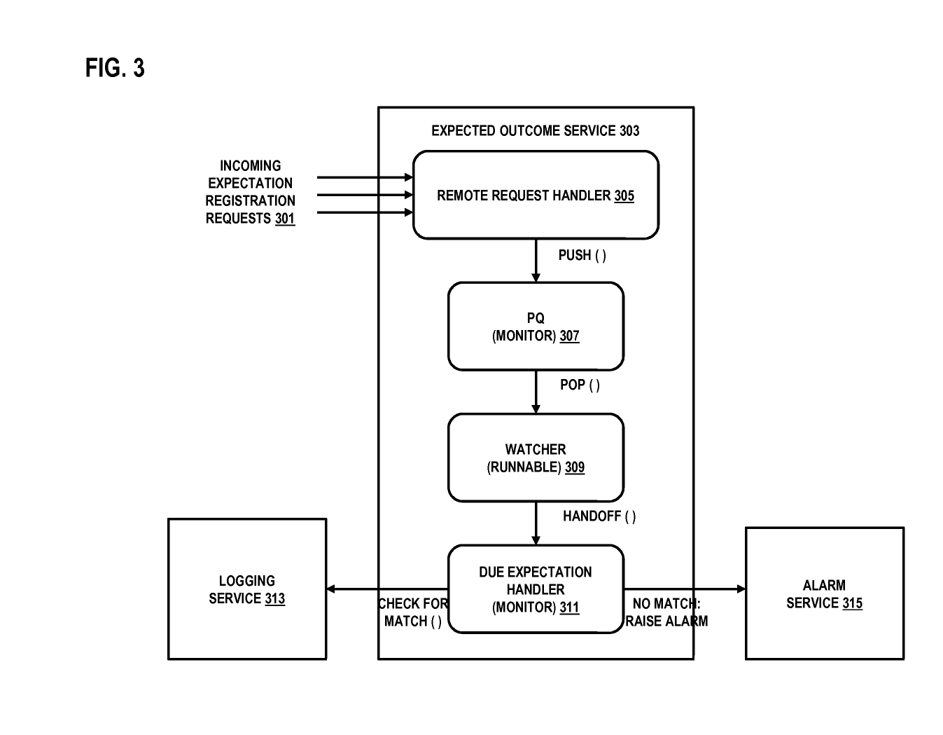

FIG. 3 is a diagram that represents the implementation process of the expected outcome service 303, according to one embodiment. The expected outcome service 303 supports the detection of error conditions. The error detection mechanism enabled by the expected outcome service 303 (i) detects when processes complete in error (by detecting the absence of the logging of a successful completion milestone), and (ii) detect when a process or sequence of activity goes awry, or missing-in-action, and never reaches a completion state, whether successful or in error. In one scenario, the expected outcome service 303 is suited for an event driven system, wherein events trigger processing activities, which, in turn, can spawn further events that trigger more activity, and so on, resulting in event cascades. In another scenario, the expected outcome service 303 may cause macro results in trouble detection, however, reference to a detailed log entries for more fine-grained forensic investigation may be pursued upon detecting an absence of an expected desirable outcome.

In one embodiment, the diagram includes an expected outcome service 303, a logging service 313, and an alarm service 315. Furthermore, the expected outcome service 303 includes a remote request handler 305 for administering incoming expectation registration requests 301, a priority queue (PQ) 307 for storing and sorting expectation objects, a watcher 309 for checking whether an expectation object is due, and a due expectation handler 311 for matching expectation information with the log entries from the logging service 313 and for raising an alarm to alarm service 315.

In one embodiment, an expectation registration request 301, once processed by the remote request handler 305 allows registration of an expectation object within the expected outcome service 303. In one scenario, the registered expectation includes various data, for example, a time window that estimates a start and end time during which the successful outcome is expected to transpire, a pattern-matching information (e.g. strings, dictionaries of key/value pairs, regular expressions, and the like) etc.

By way of example, an expectation registration request 301 may be received by the remote request handler 305. The registered expectations are pushed from the remote request handler 305 to the PQ 307, wherein these expectation instances of the expected events are stored in a sorted order. In one scenario, the PQ 307 may store enqueued objects according to some ordering criterion, and when items are popped from the head of the queue, they are popped according to the ordering criterion and not according to the order in which the items were pushed onto the queue. As a result, the PQ does not follow the first-in/first-out behavior. In one embodiment, the PQ 307 plays the role of a monitor object wherein threads do coordination calls, for example, wait and notify. In one scenario, the enqueued items are expectation objects, each of which encapsulates a Tuple (used for matching against log entries) and a time-interval. The time-interval object encapsulates a begin time and an end time, where time represent absolute system time since the Epoch.

In one embodiment, the expectation object sorted by the PQ 307 may serve as a template for detection of whether the expected desired outcome is realized within the expected time window. In one scenario, the end time represents the due date for the expectation. In other words, it is the expected time by which an outcome should have been realized if things go well. In one example embodiment, by keeping expectation objects sorted in the PQ 307 according to this due date, the watcher 309 need only keep an eye on the head of the PQ 307, and take action only when expectations at the head of the PQ 307 come due.

In one embodiment, the watcher 309 may pop an expectation object from the PQ 307 blocking on a timeout-limited wait call if no past due expectation object is at the head of the queue or if the PQ 307 is empty. In another embodiment, the enqueued expectation objects may be popped by the watcher 309 as they become due, and handed off to the due expectation handler 311. The due expectation handler 311 may check whether the expectation objects matches the logs received by the logging service 313. In one scenario, the expected outcome service 303 may query the logging service 313 to determine whether a log entry has been posted which matches the registered expected Tuple and which has a time stamp within the bounds of the expectation time-interval. If a match is found in the logging service 313, no action is taken as the expectation has been fulfilled. However, if no such match is found, then the expected outcome service 303 may consult with the alarm service 315 for causing a notification.

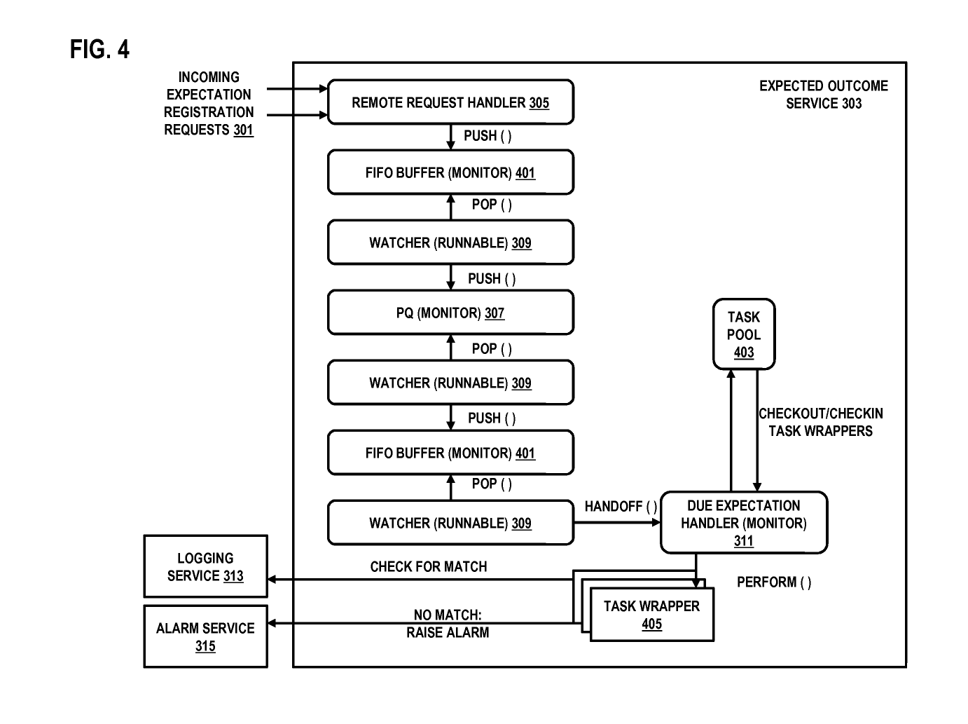

FIG. 4 is a diagram that represents a comprehensive functioning of a developed expected outcome service 303, according to one embodiment. In this example embodiment, the expected outcome service 303 may also include one or more FIFO buffers 401, a task pool 403, and a plurality of task wrappers 405. In one embodiment, the implementation of the expected outcome service 303 may amount to a pipeline in which runnable objects alternate with the monitor objects. The runnable objects may pull from the upstream monitors and may push to the downstream monitors. This is a useful multi-threaded design pattern.

In one embodiment, a FIFO buffer 401 stage may be included upstream from the PQ 307. The upstream FIFO buffer 401 may help decouple the PQ 307 from incoming requests, allowing control to be returned to remote communicators more quickly, which can reduce front-end congestion. In another embodiment, a FIFO buffer 401 appears downstream from the PQ 307, thereby allowing some buffering of past-due expectation objects if there is any congestion in the downstream interaction with the remote logging service 313 and the alarm service 315.

In one embodiment, the reference implementation has the thread pooling capability. This capability allows handler threads to be recycled, rather than being created every time an expectation comes due. In one scenario, it is in these handler threads that the interaction with the logging service 313 and the alarm service 315 occurs. In one embodiment, when an expectation object comes due, the due expectation handler 311 may call the task pool 403 check-out method which may return a task wrapper 405. In one scenario, the task wrapper 405 may contain the expectation handler task, for instance, a thread (subclass) instance, and a monitor object. After the task wrapper 405 is checked out from the task pool 403, the encapsulated expectation handler task can be accessed, and can be loaded with the relevant expectation object that has come due. Then, the task wrapper 405 perform method is called. This causes a notify call to be made on the monitor. The framework ensures that the thread instance is doing a blocking wait on the monitor. The thread then unblocks and calls the expectation handler task's perform method, which contains the custom code to perform the necessary interactions with the remote the logging service 313 and the alarm service 315.

In one embodiment, the task pool 403 may implement a policy limit on the maximum number of task wrappers 405 (and enclosed Threads) it is willing to create. In one scenario, if this limit is reached, and the upstream watcher 309 pops another past-due expectation object, then the thread of control of watcher 309 is blocked (on a wait) until a task wrapper 405 is checked back into the task pool and becomes available. In another scenario, this blocking at the task pool stage, however, does not prevent expectations from flowing through the upstream stages. They may pile up in one or more of the FIFO buffers 401, until the congestion clears downstream. In some embodiments, the systems may detect such piling up of expectation objects in FIFO buffers 401, and may take measures to reduce such congestion by launching additional processing engines, as described elsewhere in this document in discussions of scaling.

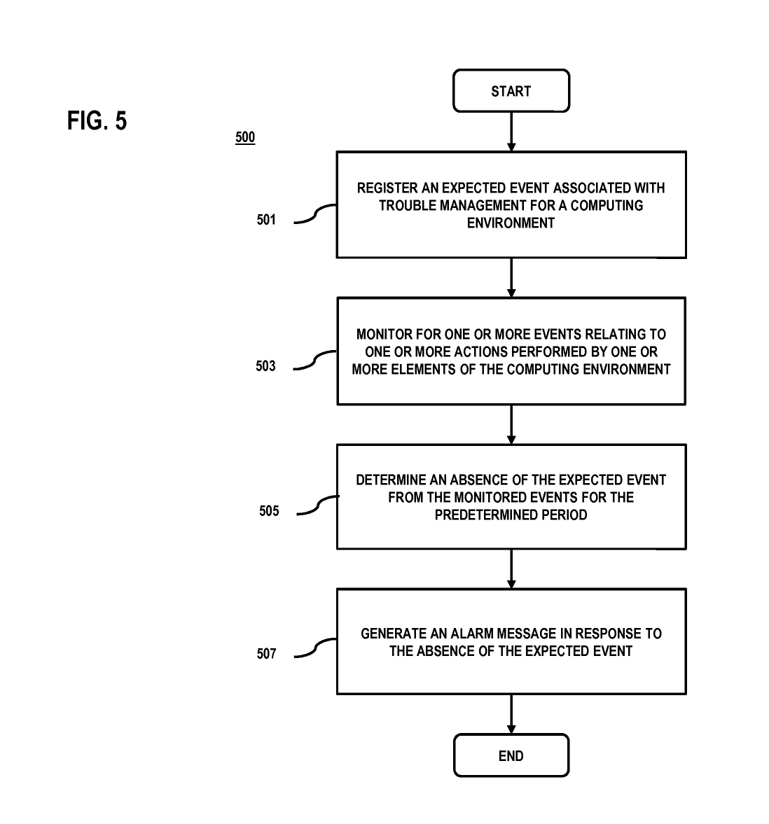

FIG. 5 is a flowchart of a process for automated error detection based on the absence of success during a predetermined time period, according to one embodiment. This flowchart may be thought of as conceptually capturing the life-cycle of one given registered expectation, charting the history of that single expectation from initial registration, through monitoring events to determine whether the expectation was fulfilled, and the final life-cycle stage where an alarm may be raised for an unfulfilled expectation. Of course in a typical implementation, multiprocessing, multi-threading, and similar techniques are employed, allowing many such expectations to exist simultaneously in the trouble management platform 115, and at any given moment the various such expectation instances will be at various respective stages of this life-cycle chart.

In step 501, the trouble management platform 115 may register an expected event associated with the trouble management for a computing environment. In another embodiment, the trouble management platform 115 may register a plurality of expected events for a plurality of computing environments as part of a managed trouble management service by a service provider, wherein the plurality of computing environments correspond respectively to a plurality of subscribers. In a further embodiment, the expected event relates to a desired end state for the computing environment. The trouble management platform 115 may determine whether the one or more events relate to an intermediate state of an activity to be executed by the computing environment. Then, the trouble management platform 115 may filter one or more events to avoid examining the events if the events are determined to be in the intermediate state.

In step 503, the trouble management platform 115 may monitor, over a predetermined period, for one or more events relating to one or more actions performed by one or more elements of the computing environment. In another embodiment, the expected event may recur based on a schedule and/or past occurrences of the expected event. In a further environment, the expected event specifies a tolerance level and/or variations on the expected event which could be used to verify the absence of the expected event.

In step 505, the trouble management platform 115 may determine an absence of the expected event from the one or more events for the predetermined period, wherein the expected event specifies the predetermined period and pattern-matching information to identify the expected event. In another embodiment, the trouble management platform 115 may examine one or more events using the pattern-matching information, wherein the pattern-matching information includes either a string, a dictionary of key/value pairs, a regular expression, or a combination thereof. In a further embodiment, the trouble management platform 115 may generate a query to determine whether a log entry corresponds to the expected event based on the pattern-matching information. Then, the trouble management platform 115 may receive a response message to the query, wherein the response message triggers the generation of the alarm message.

In step 507, the trouble management platform 115 may generate an alarm message in response to the absence of the expected event. In another embodiment, the one or more events include an alarm condition specifying at least one failure with the one or more elements of the computing environment, and wherein the expected event relates to a successful execution of an activity for the computing environment. In a further embodiment, the trouble management platform 115 may transmit the alarm message to an alarm system configured to service the computing environment.

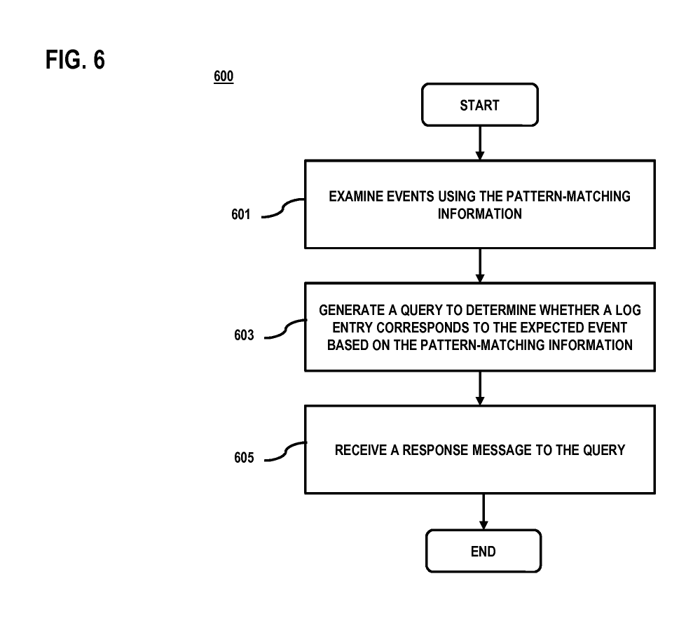

FIG. 6 is a flowchart of a process for receiving a response message to determine whether a log entry corresponds to the expected event, according to one embodiment.

In step 601, the trouble management platform 115 may examine one or more events using pattern-matching information, wherein the pattern-matching information includes a string and/or a dictionary of key/value pairs and/or a regular expression. In one embodiment, the trouble management platform 115 may specify a criterion to verify the absence of the expected event. In one scenario, the trouble management platform 115 may cause a pattern matching of one or more event attributes for detecting a desired successful completion of an event. In another scenario, the trouble management platform 115 may cause a matching of one or more tuples in at least one template, wherein the existing tuple in the log entry space can have extra attributes that aren't in the template, and there can still be a match, so long as the existing tuple does match on every relevant attribute that is in the template.

In step 603, the trouble management platform 115 may generate a query to determine whether a log entry corresponds to the expected event based on the pattern-matching information. In one scenario, the trouble management platform 115 may query the log when the expectation object comes due. The query is made to determine whether a log entry has been posted which matches the registered expected tuple and has a time stamp within the bounds of the expectation time interval.

In step 605, the trouble management platform 115 may receive a response message to the query, wherein the response message triggers the generation of the alarm message. In one scenario, the trouble management platform 115 may generate an alarm message despite the absence of failure entries. In another scenario, the trouble management platform 115 may determine that a log entry posted does not match the registered expected tuple and does not have a time stamp within the bounds of the expectation time interval, whereupon an alarm message is generated since the expectation was not been fulfilled.

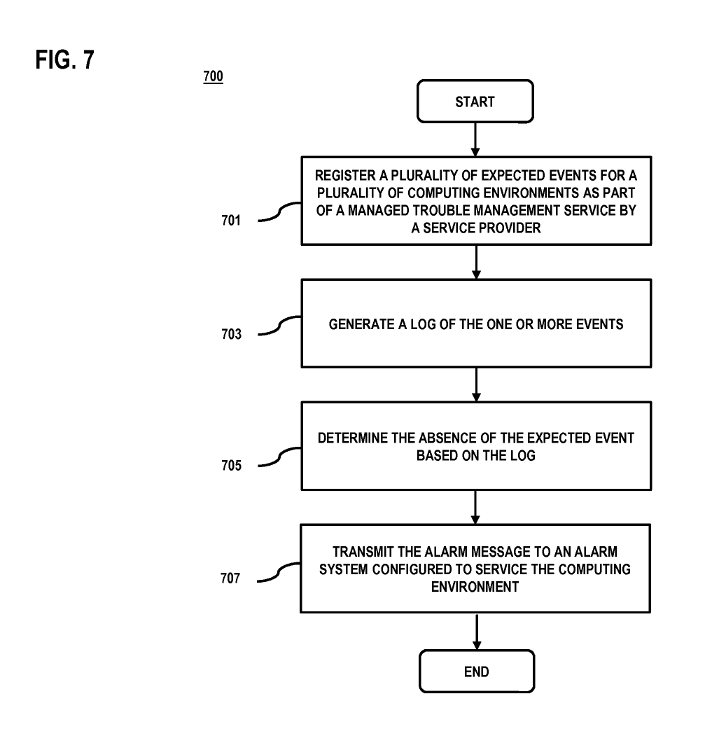

FIG. 7 is a flowchart of a process for generating a log, and monitoring a log to detect successful processing within a registered time period, according to one embodiment.

In step 701, the trouble management platform 115 may register a plurality of expected events for a plurality of computing environments as part of a managed trouble management service by a service provider. In one embodiment, the plurality of computing environments may correspond respectively to a plurality of subscribers.

In step 703, the trouble management platform 115 may generate a log of the one or more events. In one embodiment, the log records time information, date information, duration information, or a combination thereof associated with the one or more event. In another embodiment, the trouble management platform 115 may monitor the log to detect successful processing expected to occur within a registered time period. In one scenario, the log may include activities that are to be triggered on a period schedule.

In step 705, the trouble management platform 115 may determine the absence of the expected event based on the log. In one embodiment, the trouble management platform 115 may monitor events to determine whether the expectation was fulfilled, and may transmit an alarm message to an alarm system configured to service the computing environment to raise an alarm for any unfulfilled expectation (step 707).

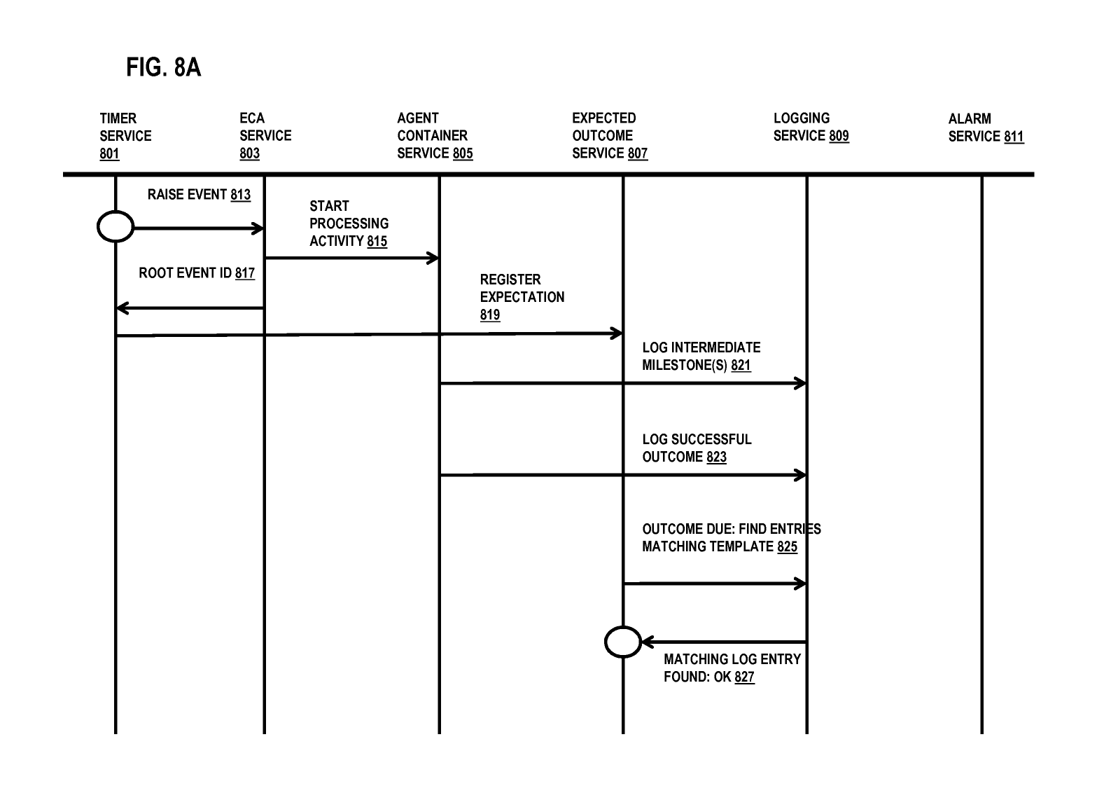

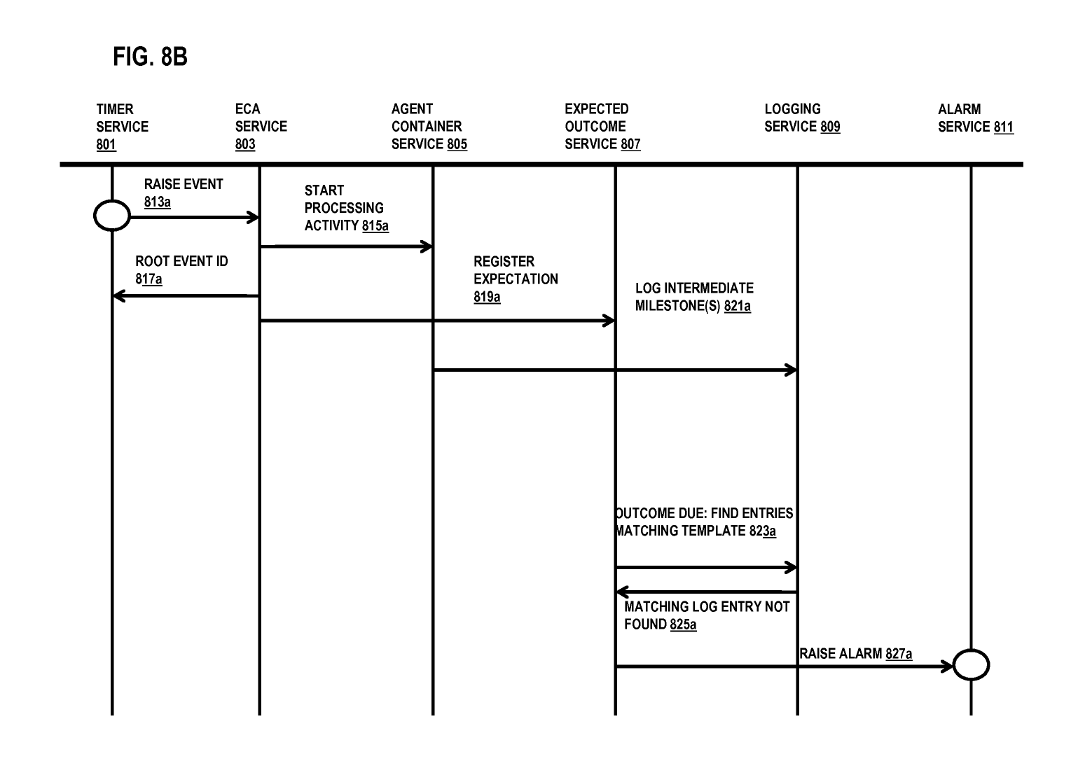

FIG. 8 A-B are ladder diagrams that represents a scenario on handling recurring expectations using the combination of timer service and expected outcome service, according to one example embodiment. The scenario commences with the time-based triggering of processing activities by the timer service 801. The example scenario completes after the processing activity running in the agent container service 805 posts a “successful outcome” milestone [823] to the logging service 809, and the expected outcome service 807 subsequently confirms that a log entry matching a registered expectation is found in the logging service 809. FIG. 8A thus depicts an example “expectation fulfilled” scenario.

In one scenario, the timer service 801 is configured to raise a particular root event at some scheduled time each day, or on some other more complicated schedule [813]. In one exemplary embodiment, the act of raising an event is accomplished by the timer service 801 sending a “raise event” [813] request to the ECA Service 803 (Event/Condition/Action Service) which manages the spawning of event handler activities in response to events being raised. The event that is raised triggers action code in the agent container service 805. The processing that is triggered is application-specific according to the problem domain and the type of the particular event that is raised. Upon receiving the “raise event” request [813], the ECA Service 803 also generates a unique Root Event ID [817] and returns that identifier to the Timer Service 801. The root event raised by the timer service 801 spawns asynchronous activities in the agent container service 805. Without blocking for completions of those asynchronous activities, the timer service 801 may immediately, upon receiving the Root Event ID [817], register an expectation [819] with the expected outcome service 807, thereby informing the expected outcome service 807 on what patterns to look for in the logging service entries to verify that the end desired activity has successfully occurred. In some embodiments, the pattern matching information sent from the timer service 801 to the expected outcome service 807 as part of the register expectation request [819] would include the Root Event ID. The inclusion of Root Event ID information in expectation registrations allows subsequent verifications of expectation fulfillment to include pattern matching of log entries based in part on Root Event ID, thus allowing the system to correlate and distinguish among multiple instances of similar events and processing activities that could be happening contemporaneously in the environment. In one scenario, in an event driven system, similar types of events may occur at the same time, as opposed to a batch processing system where a single occurrence of similar type of events may kick-off one at a time. Since numerous similar types of events may initiate processing, there is a need for sorting these events. Accordingly, in a typical event driven processing environment, when an event occurs and the processing is initiated, the trouble management platform 115 may ensure that there is a unique event identifier that distinguishes the events of similar types. In another scenario, during the occurrence of a processing and the posting of the milestones to the logging service, it is essential to have the unique event identifier as a part of the record in the log. Further, during the expected outcome style of trouble management, it is critical that the expectation include the unique event identifiers for matching the expectations with the instance of the event driven activities. In a further scenario, where an event may initiate a processing, and it may spawn more events to initiate more processing, it is important for activities within cascades to be tied together, for example, unique event identifiers may bind similar activity cascades together. In the event management system, when the original event spawns the cascade and raises an event, a root event identifier in the event is returned. It is a way of tying everything together, whether it is a processing of the original event or the processing of the subordinate event, they can all include the same root identifier. In such manner, an expectation may be tied to complex event-driven processing activities and logged process milestones. Meanwhile, as the agent container service 805 runs processing activities asynchronously, it may, in some embodiments, log intermediate milestone entries [821] in the logging service 809. In certain scenarios, the timer service has not been configured to register expectations concerning such intermediate milestones, and hence the expected outcome service 807 exercises no tracking of such intermediate milestones. Once the agent container service 805 successfully completes the processing activities triggered by the root event, it will log a successful outcome entry in the logging service 809 [823]. Finally, when the expected outcome service 807 detects (using its internal watcher mechanisms) that the above-discussed expected outcome has come due, it will reach out to the logging service 809 to confirm that the expected successful outcome log entry has been posted during the expected time window [825, 827]. On the other hand, if the expected final outcome was not logged, the expected outcome service 807 may raise an alarm with the alarm service.

FIG. 8B depicts a similar usage scenario as FIG. 8A, except that in the case of FIG. 8B, the activities in the agent container service 805 fails to post a successful outcome milestone to the logging service 809. In this scenario, when the registered expectation comes due, and the expected outcome service 807 attempts to find a log entry matching the registered expectation template [823a], the logging service 809 replies [825a] that no matching log entry is found, whereupon the expected outcome service 807 raises an alarm [827a] with the alarm service 811. FIG. 8B thus depicts an example “expectation unfulfilled” scenario.

The computer system 900 may be coupled via the bus 901 to a display 911, such as a cathode ray tube (CRT), liquid crystal display, active matrix display, or plasma display, for displaying information to a computer user. An input device 913, such as a keyboard including alphanumeric and other keys, is coupled to the bus 901 for communicating information and command selections to the processor 903. Another type of user input device is a cursor control 915, such as a mouse, a trackball, or cursor direction keys, for communicating direction information and command selections to the processor 903 and for controlling cursor movement on the display 911.

According to an embodiment of the invention, the processes described herein are performed by the computer system 900, in response to the processor 903 executing an arrangement of instructions contained in main memory 905. Such instructions can be read into main memory 905 from another computer-readable medium, such as the storage device 909. Execution of the arrangement of instructions contained in main memory 905 causes the processor 903 to perform the process steps described herein. One or more processors in a multiprocessing arrangement may also be employed to execute the instructions contained in main memory 905. In alternative embodiments, hard-wired circuitry may be used in place of or in combination with software instructions to implement the embodiment of the invention. Thus, embodiments of the invention are not limited to any specific combination of hardware circuitry and software. The mobile system 900 may further include a Read Only Memory (ROM) 907 or other static storage device coupled to the bus 901 for storing static information and instructions for the processor 903.

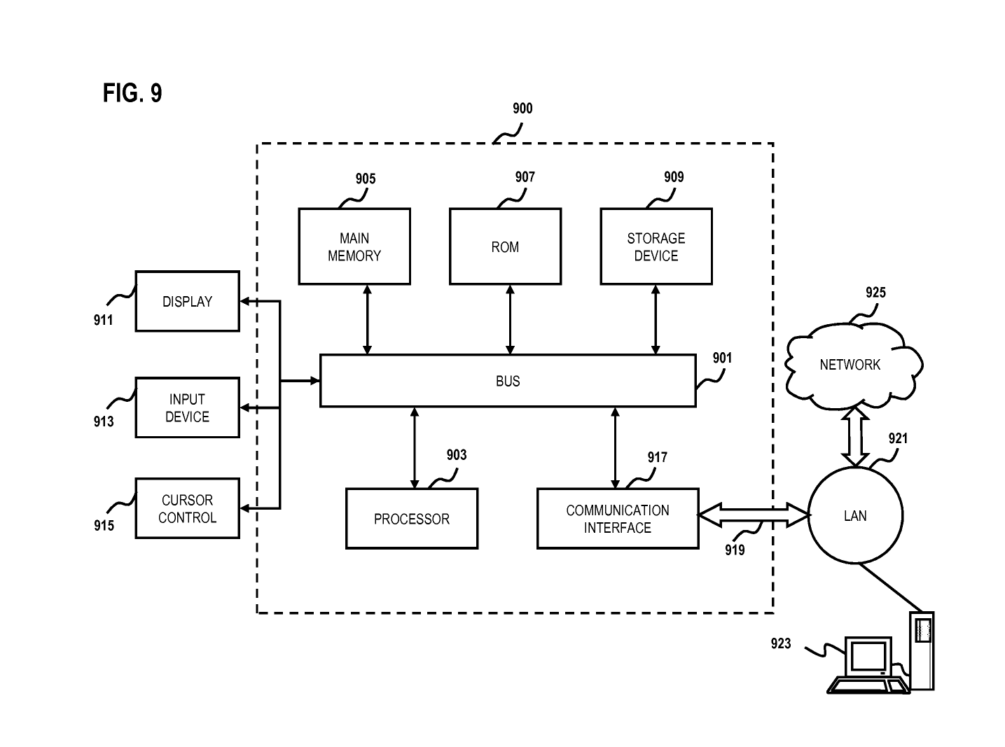

The computer system 900 also includes a communication interface 917 coupled to bus 901. The communication interface 917 provides a two-way data communication coupling to a network link 919 connected to a local network 921. For example, the communication interface 917 may be a digital subscriber line (DSL) card or modem, an integrated services digital network (ISDN) card, a cable modem, a telephone modem, or any other communication interface to provide a data communication connection to a corresponding type of communication line. As another example, communication interface 917 may be a local area network (LAN) card (e.g. for Ethernet™ or an Asynchronous Transfer Model (ATM) network) to provide a data communication connection to a compatible LAN. Wireless links can also be implemented. In any such implementation, communication interface 917 sends and receives electrical, electromagnetic, or optical signals that carry digital data streams representing various types of information. Further, the communication interface 917 can include peripheral interface devices, such as a Universal Serial Bus (USB) interface, a PCMCIA (Personal Computer Memory Card International Association) interface, etc. Although a single communication interface 917 is depicted in FIG. 9, multiple communication interfaces can also be employed.

The network link 919 typically provides data communication through one or more networks to other data devices. For example, the network link 919 may provide a connection through local network 921 to a host computer 923, which has connectivity to a network 925 (e.g. a wide area network (WAN) or the global packet data communication network now commonly referred to as the “Internet”) or to data equipment operated by a service provider. The local network 921 and the network 925 both use electrical, electromagnetic, or optical signals to convey information and instructions. The signals through the various networks and the signals on the network link 919 and through the communication interface 917, which communicate digital data with the computer system 900, are exemplary forms of carrier waves bearing the information and instructions.

The computer system 900 can send messages and receive data, including program code, through the network(s), the network link 919, and the communication interface 917. In the Internet example, a server (not shown) might transmit requested code belonging to an application program for implementing an embodiment of the invention through the network 925, the local network 921 and the communication interface 917. The processor 903 may execute the transmitted code while being received and/or store the code in the storage device 909, or other non-volatile storage for later execution. In this manner, the computer system 900 may obtain application code in the form of a carrier wave.

The term “computer-readable medium” as used herein refers to any medium that participates in providing instructions to the processor 903 for execution. Such a medium may take many forms, including but not limited to non-volatile media, volatile media, and transmission media. Non-volatile media include, for example, optical or magnetic disks, such as the storage device 909. Volatile media include dynamic memory, such as main memory 905. Transmission media include coaxial cables, copper wire and fiber optics, including the wires that comprise the bus 901. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

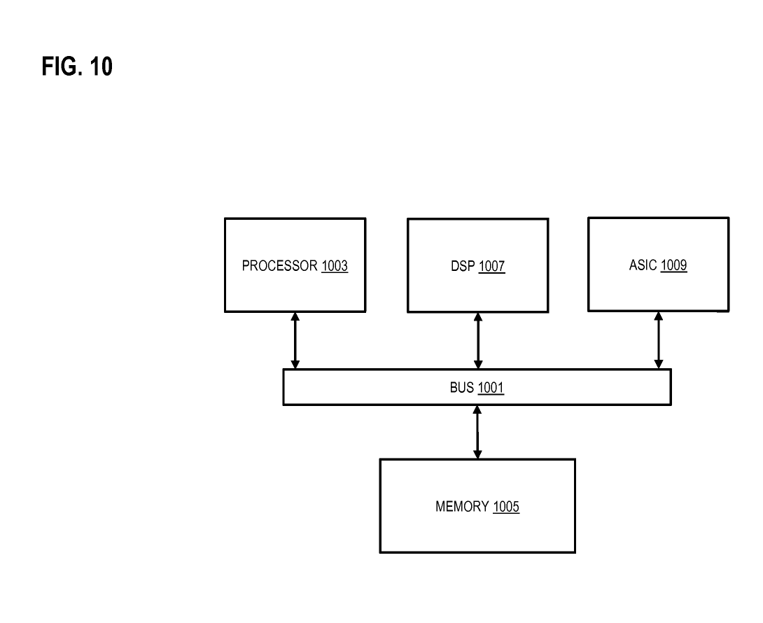

FIG. 10 illustrates a chip set 1000 upon which an embodiment of the invention may be implemented. Chip set 1000 is programmed to present a slideshow as described herein and includes, for instance, the processor and memory components described with respect to FIG. 10 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 1000, or a portion thereof, constitutes a means for performing one or more steps of FIGS. 5-7.

In one embodiment, the chip set 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to controlling a set-top box based on device events. The memory 1005 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method comprising:
registering an expected event associated with trouble management for a computing environment;
monitoring, over a predetermined period, for one or more events relating to one or more actions performed by one or more elements of the computing environment;
determining an absence of the expected event from the one or more events for the predetermined period; and
generating an alarm message in response to the absence of the expected event.

2. A method according to claim 1, wherein the expected event specifies the predetermined period and pattern-matching information to identify the expected event, the method further comprising:
examining the one or more events using the pattern-matching information, wherein the pattern-matching information includes a string, a dictionary of key/value pairs, a regular expression, or a combination thereof.

3. A method according to claim 2, further comprising:
generating a query to determine whether a log entry corresponds to the expected event based on the pattern-matching information; and
receiving a response message to the query, wherein the response message triggers the generation of the alarm message.

4. A method according to claim 2, wherein the expected event specifies a criterion to verify the absence of the expected event.

5. A method according to claim 1, wherein the one or more events include an alarm condition specifying at least one failure with the one or more elements of the computing environment, and wherein the expected event relates to a successful execution of an activity for the computing environment.

6. A method according to claim 1, further comprising:
transmitting the alarm message to an alarm system configured to service the computing environment.

7. A method according to claim 1, further comprising:
registering a plurality of expected events for a plurality of computing environments as part of a managed trouble management service by a service provider,
wherein the plurality of computing environments correspond respectively to a plurality of subscribers.

8. A method according to claim 1, further comprising:
generating a log of the one or more events, wherein the log records time information, date information, duration information, or a combination thereof associated with the one or more event; and
determining the absence of the expected event based on the log.

9. A method according to claim 1, wherein the expected event may recur based on a schedule, a past occurrence of the expected event, or a combination thereof.

10. An apparatus comprising a processor configured to:
register an expected event associated with trouble management for a computing environment;
monitor, over a predetermined period, for one or more events relating to one or more actions performed by one or more elements of the computing environment;
determine an absence of the expected event from the one or more events for the predetermined period; and
generate an alarm message in response to the absence of the expected event.

11. An apparatus according to claim 10, wherein the expected event specifies the predetermined period and pattern-matching information to identify the expected event, the apparatus is further configured to:
examine the one or more events using the pattern-matching information, wherein the pattern-matching information includes a string, a dictionary of key/value pairs, a regular expression, or a combination thereof.

12. An apparatus according to claim 11, wherein the apparatus is further configured to:
generate a query to determine whether a log entry corresponds to the expected event based on the pattern-matching information; and
receive a response message to the query, wherein the response message triggers the generation of the alarm message.

13. An apparatus according to claim 11, wherein the expected event specifies a criterion to verify the absence of the expected event.

14. An apparatus according to claim 10, wherein the one or more events include an alarm condition specifying at least one failure with the one or more elements of the computing environment, and wherein the expected event relates to a successful execution of an activity for the computing environment.

15. An apparatus according to claim 10, further comprising:
transmit the alarm message to an alarm system configured to service the computing environment.

16. An apparatus according to claim 10, further comprising:
register a plurality of expected events for a plurality of computing environments as part of a managed trouble management service by a service provider,
wherein the plurality of computing environments correspond respectively to a plurality of subscribers.

17. An apparatus according to claim 10, further comprising:
generate a log of the one or more events, wherein the log records time information, date information, duration information, or a combination thereof associated with the one or more event; and
determine the absence of the expected event based on the log.

18. An apparatus according to claim 10, wherein the expected event may recur based on a schedule, a past occurrence of the expected event, or a combination thereof.

19. A system comprising:
a trouble management platform configured to register an expected event associated with trouble management for a computing environment; to monitor, over a predetermined period, for one or more events relating to actions performed by one or more elements of the computing environment; to determine absence of the expected event from the one or more events for the predetermined period; and to generate an alarm message in response to the determined absence of the expected event.

20. A system of claim 19, wherein the expected event specifies the predetermined period and pattern-matching information to identify the expected event, the trouble management platform is further configured to examine the one or more events using the pattern-matching information, wherein the pattern-matching information includes a string, a dictionary of key/value pairs, a regular expression, or a combination thereof.
